(19) United States
(12) Patent Application Publication
(10) Pub. No.: US 2018/0365810 A1
(43) Pub. Date: Dec. 20, 2018

(54) OBJECT IMAGE RECOVERY FROM DIGITAL HOLOGRAMS

(71) Applicant: INDIAN INSTITUTE OF TECHNOLOGY DELHI, New Delhi (IN)

(72) Inventors: Kedar Bhalchandra KHARE, New Delhi (IN); Joby Joseph, New Delhi (IN); Mandeep Singh, New Delhi (IN)

(73) Assignee: INDIAN INSTITUTE OF TECHNOLOGY DELHI, New Delhi (IN)

(21) Appl. No.: 16/062,088

(22) PCT Filed: Dec. 12, 2016
(86) PCT No.: PCT/IB2016/057534

§ 371 Date: Jun. 13, 2018

(30) Foreign Application Priority Data
Dec. 14, 2015 (IN) 4097/DEL/2015

(51) Int. Cl. G06T 5/00; G03H 1/04; G03H 1/00; G03H 1/08

(52) U.S. Cl. CPC G06T 5/003; G03H 1/0443; G03H 1/0005; G03H 2001/0456; G06T 2207/10056; G06T 2207/30024; G03H 2001/005; G03H 1/0866

(57) ABSTRACT

Technologies are generally described to recover diffraction limited amplitude and phase images of objects from single shot image plane hologram data. In some examples, an image processor may receive digital hologram data derived from interference between a reference signal and an unknown object image. The image processor may then attempt to recover a version of the unknown object image by minimizing a cost function associated with the reference signal and the digital hologram data. The cost function may include a data-fit cost component and a constraint cost component, and the image processor may iteratively minimize the cost function by alternately minimizing the data-fit cost component and the constraint cost component.

### BACKGROUND

Unless otherwise indicated herein, the materials described in this section are not prior art to the claims in this application and are not admitted to be prior art by inclusion in this section.

Image plane holographic imaging of an object may involve the recording of a hologram where an object wave at the hologram plane corresponds to the nominal image plane for the object being imaged. Digital holographic microscopes may be configured to capture image plane digital holograms by interfering a reference beam that is temporally coherent with respect to the object wave, resulting in a holographic or interferometric image of the object. Such holographic imaging, known as single-shot image plane holography, may allow an in-focus image at any plane in the object to be computed based on known intensity variations at the detector.

### SUMMARY

The present disclosure generally describes techniques to recover object images from digital hologram data.

According to some examples, an object image recovery system is provided. The object image recovery system may include a memory and a processor block coupled to the memory. The memory may be configured to store digital hologram data derived from a combination of a reference signal and an unknown object image. The processor block may be configured to determine a data-fit cost based on an object-image intermediate and the reference signal, determine a constraint cost based on the object-image intermediate, and perform one or more minimization iterations of the data-fit cost and the constrain cost. Each minimization iteration may include a minimization of the data-fit cost based on a first object-image estimate to generate a second object-image estimate and one or more minimizations of the constraint cost based on the second object image estimate to generate a third object-image estimate. The processor block may be further configured to, upon determination that a halt criterion has been met, recover a version of the unknown object image from the digital hologram data based on the second object-image estimate and/or the third object-image estimate. In some embodiments, the recovered version of the unknown object image may include a diffraction-limited phase component.

According to other examples, a method is provided to recover object image data from a single image plane hologram. The method may include receiving a digital hologram derived from a reference signal and an unknown object image, determining a data-fit cost associated with the digital hologram and based on an object-image intermediate and the reference signal, and determining a constraint cost associated with the digital hologram and based on the object-image intermediate. The method may further include performing multiple minimization iterations of the data-fit cost and the constraint cost, where each minimization iteration may include performing a minimization of the data-fit cost based on a first object-image estimate to generate a second object-image estimate and performing one or more minimizations of the constraint cost based on the second object-image estimate to generate a third object-image estimate. The method may further include recovering a version of the unknown object image from the digital hologram based on one or more of the second object-image estimate and the third object-image estimate. In some embodiments, the recovered version of the unknown object image may include a diffraction-limited phase component.

According to further examples, a digital holography imaging system is provided. The digital holography imaging system may include a holographic imager and an object image recovery module. The holographic imager may be configured to generate a single-shot digital hologram of an object using a reference signal. The object image recovery module may be configured to determine a cost function associated with the digital hologram and including a data-fit cost and a constraint cost. The object image recovery module may be further configured to alternately perform a first minimization of the cost function by evaluation of the data-fit cost based on a first object-image estimate to generate a second object-image estimate and perform a second minimization of the cost function by evaluation of the constraint cost based on the second object-image estimate to generate a third object-image estimate. The object image recovery module may be further configured to recover a version of the unknown object image from the digital hologram based on one or more of the second object-image estimate and the third object-image estimate. In some embodiments, the recovered version of the unknown object image may include a diffraction-limited phase component.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system configured to recover image data associated with an object;

FIG. 2 illustrates an example image processor configured to recover image data associated with an object;

FIG. 3 is a flow diagram illustrating an example process to recover object image data from object hologram data;

FIG. 4 illustrates example images of a simulated object recovered using a Fourier transform method and the alternating iteration minimization method described in FIG. 3;

FIG. 5 illustrates example images recovered using a method without alternating iteration and the alternating iteration minimization method described in FIG. 3;

FIG. 6 illustrates a general purpose computing device, which may be used to recover object image data from object hologram data;

FIG. 7 is a flow diagram illustrating an example method to recover object image data from object hologram data that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to recovering image data from hologram data.

Briefly stated, technologies are generally described to recover object image data from object hologram data. In some examples, an image processor may receive digital hologram data derived from interference between a reference signal and an unknown object image. The image processor may then attempt to recover a version of the unknown object image by minimizing a cost function associated with the reference signal and the digital hologram data. The cost function may include a data-fit cost component and a constraint cost component, and the image processor may iteratively minimize the cost function by alternately minimizing the data-fit cost component and the constraint cost component.

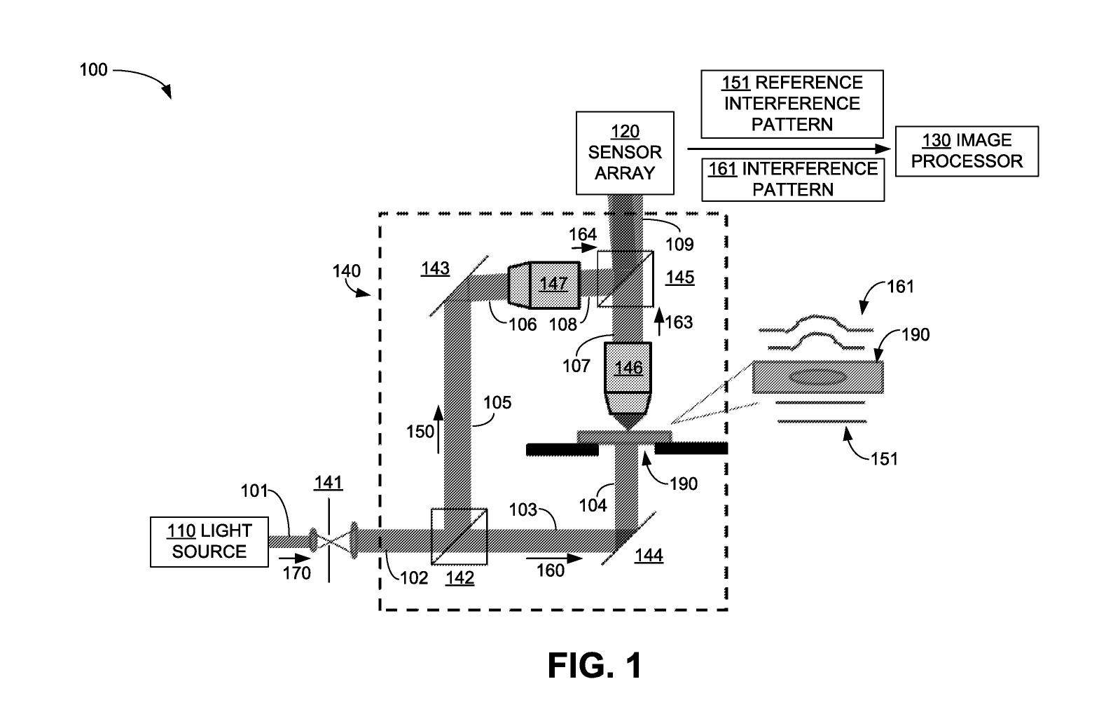

FIG. 1 illustrates an example system 100 configured to recover image data associated with an object, arranged in accordance with at least some embodiments described herein.

The system 100 may include one or more components such as a light source 110, a sensor array 120, an image processor 130, and an optical assembly 140. The optical assembly 140 may include additional components, such as a spatial filter 141, first and second beam splitters 142 and 145, first and second mirrors 143 and 144.

In some embodiments, the light source 110 may include an output aligned along a first optical path 101. The first optical path 101 may be aligned with a first side of the spatial filter 141, and a second side of the spatial filter may be aligned with a second optical path 102. The second optical path 102 may be aligned with a first side of the first beam splitter 142, and a second side of the first beam splitter 142 may be aligned with a third optical path 103. The third optical path 103 may be aligned with a surface of the second mirror 144, which may also be aligned with a fourth optical path 104. The fourth optical path 104 may in turn be aligned with a first side of a first microscope objective 146. A second side of the first microscope objective 146 may be aligned with a seventh optical path 107, which may then be aligned with a first side of the second beam splitter 145.

The first side of the first beam splitter 142 may also be aligned with a fifth optical path 105. The fifth optical path 105 in turn may be aligned with a surface of the first mirror 143, which may also be aligned with a sixth optical path 106. The sixth optical path 106 may be aligned with a first side of a second microscope objective 147. A second side of the second microscope objective 147 may be aligned with an eighth optical path 108, which may further be aligned with a second side of the second beam splitter 145. The second side of the second beam splitter 145 may also be aligned with a ninth optical path 109, which may be aligned with an input of the sensor array 120. An output of the sensor array 120 may then be coupled to the image processor 130.

During operation of the system 100, the light source 110 may be configured to transmit or project a beam 170 along the optical path 101 to the spatial filter 141, which in turn may pass a filtered beam to the first beam splitter 142 along the optical path 102. The first beam splitter 142 may be configured to receive the filtered beam, reflect a first portion of the filtered beam along the optical path 105 as a reference beam 150, and transmit a second portion of the filtered beam along the optical path 103 as an object beam 160. The first mirror 143 may be configured to receive and reflect the reference beam 150 along the optical path 106 to the second microscope objective 147. The second microscope objective may focus and/or otherwise adjust the reference beam 150 to form an adjusted reference beam 164 and provide the adjusted reference beam 164 to the second beam splitter 145 along the eighth optical path 108. The second mirror 144 may be configured to receive and reflect the object beam 160 along the optical path 104.

In some embodiments, an object 190 may be positioned in the optical path 104 and illuminated by the object beam 160. The microscope objective 146 may be configured to receive a portion of the object beam 160 from the optical path 104 and focus and/or otherwise adjust the received portion to form an adjusted object beam 163. The microscope objective 146 may then transmit the adjusted object beam 163 to the second beam splitter 145 along the optical path 107. In some embodiments, the microscope objective 146 may be configured such that the adjusted object beam 163 represents an image plane hologram of the object 190, where the plane of the hologram is at or near the image plane for the object 190. The sharp edges in the object are focused and distinct in the image plane. Thus, there is no blurring of information. The challenge for single shot image plane holography has been that the conventional methods such as the Fourier transform method inherently involve low-pass filtering and thus may not recover information about the sharp edges. A system according to embodiments may allow recovery of the sharp/high frequency features from a single shot hologram.

The second beam splitter 145 may be configured to receive the adjusted reference beam 164 and the adjusted object beam 163 from the eighth optical path 108 and the seventh optical path 107 and combine the beams into a captured interference pattern 161. In situations where the adjusted object beam 163 represents an image plane hologram of the object 190, the captured interference pattern 161 may encode information about the amplitude and phase of the field of light waves in the image plane for the object 190. The second beam splitter 145 may then transmit the captured interference pattern 161 to the sensor array 120 along the ninth optical path 109. Thus, phase information may be collected with the help of the reference interference pattern 151 and captured interference pattern 161 associated with the object 190 (sample) using the illustrated example configuration or similar configurations.

In some embodiments, the various components illustrated as part of the optical assembly 140 may be rearranged. For example, the first beam splitter 142 may be configured to transmit to object 190 without the use of the second mirror 144, or to the second microscope objective 147 without the use of the first mirror 143. In some embodiments, the second microscope objective 147 may not be present. The first microscope objective 146 may be configured to transmit to another optical device (for example, a mirror, a lens, a filter, etc.) that may be aligned with the second beam splitter 145 such that the microscope objective 146 indirectly transmits beams to the second beam splitter 145. In some embodiments, a tube lens may be added between the second beam splitter 145 and the sensor array 120. Additional mirrors, lenses, and filters may also be employed throughout the system to facilitate an efficient or convenient physical orientation as may be desired in other implementations, while maintaining a substantially similar operational result.

In some embodiments, the light source 110 may include one or more of a helium-neon laser, a solid state diode laser, a gas laser, or any suitable combination thereof. The light source 110 may be selected based upon properties such as spatial coherence extending over a desired sample area and temporal coherence. For example, light fields in the reference beam 150 and the object beam 160 may travel different optical paths, and sufficient temporal coherence may be maintained in order to observe interference. The light source 110 may be configured to generate the beam 170 as a plane beam, a spherical beam, and/or a coded beam. In some embodiments, the light source 110 may be configured to generate the beam 170 as an ultraviolet beam, a visible beam, an infrared beam, a terahertz beam, an X-ray beam, or a beam of any suitable wavelength.

As described above, the optical assembly 140 may be configured to receive the reference beam 150 and an object beam 160 and adjust the reference beam 150 to form an adjusted reference beam 164. The adjusted reference beam 164 may correspond to a reference interference pattern 151, and the object beam 160 may be associated with the object 190. In some embodiments, the reference interference pattern 151 may be generated by the optical assembly 140 based on the interference of multiple plane waves. The generated reference interference pattern 151 may be captured by the sensor array 120 and used to recover image data associated with the object 190 by the image processor 130. The sensor array 120 may be configured to capture or record the interference between the different beams. In some embodiments, the optical assembly 140 may be configured to interfere the adjusted reference beam 164 with the object beam 160 to generate the captured interference pattern 161.

The optical assembly 140 may include an interferometer configured to generate the reference interference pattern 151 based on an interference of multiple plane waves. In some embodiments, the interferometer may be a commercially available interferometer. Examples of such interferometers may include, but are not limited to, a Mach-Zehnder interferometer, a Michelson Twyman-Green interferometer, a point-diffraction interferometer, a shearing interferometer, a Talbot interferometer, a Lau-Talbot interferometer, any other suitable interferometer, or any combination thereof.

In some embodiments, the first mirror 143 may be configured to provide a tilt in the reference beam 150 for an off-axis digital holographic microscope (DHM) configuration. The object beam 160 transmitted to the object 190 may be reflected from the object 190 to generate a reflected beam 163 that interferes with the adjusted reference beam 164. The first microscope objective 146 may be configured to receive reflected light from the object 190 over a desired field of view. The sensor array 120 may be configured to receive the captured interference pattern 161 generated by the interference of the adjusted reference beam 164 and the object beam 160.

The image processor 130 may be configured to receive an output of the optical assembly 140, such as the reference interference pattern 151 and the captured interference pattern 161. The image processor 130 may be configured to process the received data to recover image data associated with the object 190.

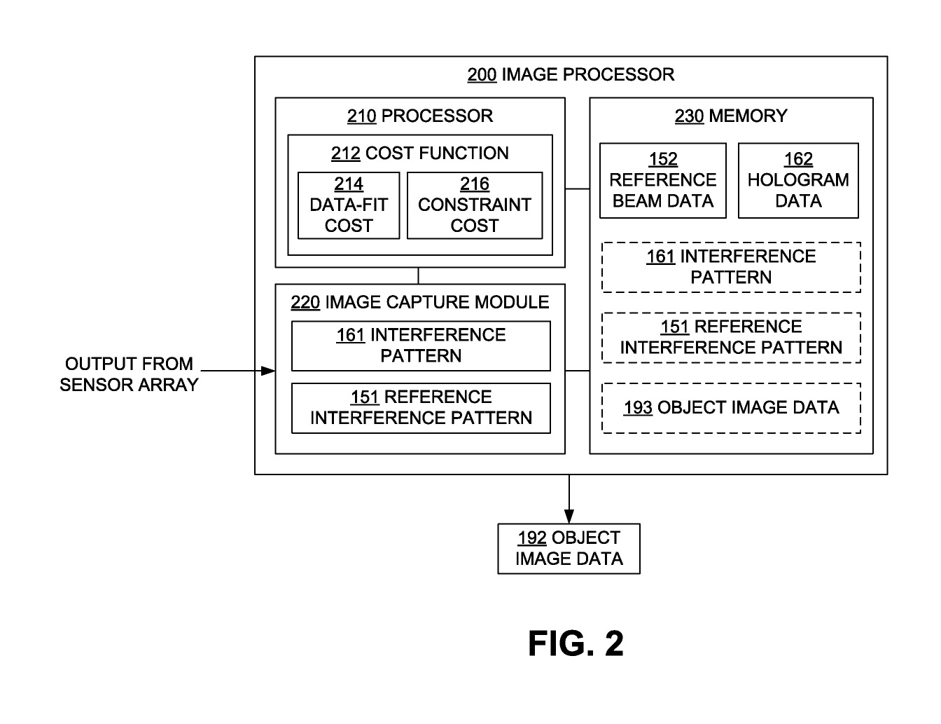

FIG. 2 illustrates an example image processor 200 configured to recover image data associated with an object, arranged in accordance with at least some embodiments described herein.

The image processor 200, which may be similar to the image processor 130, may include one or more components such as a processor 210, an image capture module 220, and a memory 230, each coupled to each other. The image capture module 220 may further be coupled to a sensor array such as the sensor array 120.

In some embodiments, the image capture module 220 may be configured to receive output from the coupled sensor array. For example, the image capture module 220 may receive the reference interference pattern 151 and/or the captured interference pattern 161 from the coupled sensor array. The image capture module 220 may then provide the reference interference pattern 151 and/or the captured interference pattern 161 to the memory 230 for storage and/or to the processor 210 for subsequent processing to recover image data associated with an object (for example, the object 190). In some embodiments, the memory 230 may also receive and store reference beam data 152 corresponding to the reference interference pattern 151 and hologram data 162 corresponding to the captured interference pattern 161.

In some embodiments, the processor 210 may be configured to apply a cost function 212 to the hologram data 162 and the reference beam data 152 and to iteratively reduce the cost function 212 to recover object image data 192 corresponding to the object 190. For example, the cost function 212 may be associated with a data-fit cost 214 and a constraint cost 216, and the processor 210 may be configured to reduce the cost function 212 by iteratively reducing the data-fit cost 214 and the constraint cost 216. In some embodiments, the memory 230 may be configured to store intermediate object image data 193 while the processor 210 iteratively reduces the cost function 212.

A variety of cost functions, data-fit costs, and constraint costs may be used by the image processor 200. In some embodiments, example cost functions may implement least squares (L2-norm) techniques, weighted least squares techniques, maximum entropy reconstruction techniques, maximum-likelihood reconstruction techniques, expectation maximization techniques, any other suitable techniques, or combinations thereof. In some embodiments, the processor 210 may be configured to reduce the data-fit cost 214 and the constraint cost 216 based on backtracking line search techniques, edge-preserving constraint techniques, or any suitable technique. Such edge-preserving constraint techniques may be implemented using one or more of a total variation technique, a Huber loss function, and/or a pseudo-Huber loss function.

The image processor 130 may be configured to process the obtained object image data 192 to recover the image of the object 190. For example, the obtained object image data 192 may be convolved with a Fresnel impulse response or by using an angular spectrum method to recover the focused image of the object 190 in any suitable plane of interest in depth. In some examples, an image resolution of the image of the object 190 recovered using a single hologram frame recorded on the sensor array 120 may be smaller than the image resolution estimated using the relationship 3λ/2 sin θ, where λ may be the wavelength of light used and θ may be the nominal angle between the object beam 160 and the reference beam 150. The lateral image resolution may be substantially similar to the diffraction-limited resolution obtained using the first microscope objective 146, where a diffraction-limited resolution represents the theoretical resolution limit of a particular optical instrument. The recovered image of the object 190 may be a complex-valued object image that includes both amplitude and phase components. In particular, the recovered phase components may allow subsequent recovery of depth information associated with the hologram image, which may be useful for imaging of transparent objects, such as unstained cells.

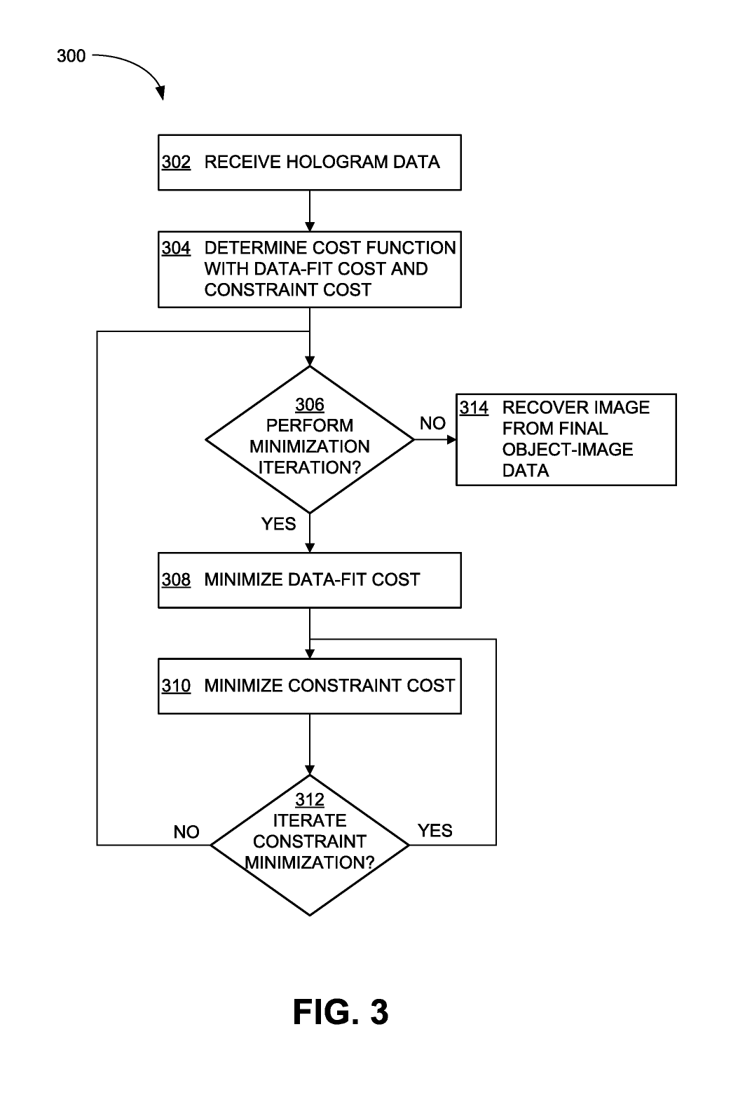

FIG. 3 is a flow diagram illustrating an example process 300 to recover object image data from object hologram data, arranged in accordance with at least some embodiments described herein. Process 300 may include one or more operations, functions, or actions as illustrated by one or more of blocks 302-314. Although some of the blocks in process 300 (as well as in any other process/method disclosed herein) are illustrated in a sequential order, these blocks may also be performed in parallel, and/or in a different order that those described herein. Also, the various blocks may be combined into fewer blocks, divided into additional blocks, and/or eliminated based upon the particular implementation. Additional blocks representing other operations, functions, or actions may be provided.

According to process 300, object image data recovery from object hologram data may begin at block 302 (“Receive hologram data”), where an image processor such as the image processor 200 may receive hologram data associated with an imaged object (for example, the hologram data 162). As described above, the hologram data may correspond to a captured interference pattern (for example, the interference pattern 161), which in turn may be generated by the interference of an adjusted reference beam (for example, the beam 164) and an object beam (for example, the beam 160). In some embodiments, the hologram data may be described as:

H=|O|²+|R|²+OR*+O*R,

where R represents an expression for the adjusted reference beam and O represents an expression for the object beam at the sensor array 120.

Since O may be a complex-valued field having both amplitude and phase values and H may be a real-valued image, O may have multiple solutions, even if R is known. Accordingly, an appropriate solution may be selected based on an appropriate image domain constraint. In some embodiments, this may be done using a cost function with appropriate parameters, as described below.

At block 304 (“Determine cost function with data-fit cost and constraint cost”), which may follow block 302, the image processor may determine a cost function with a data-fit cost (for example, the data-fit cost 214) and a constraint cost (for example, the constraint cost 216) for use in recovering an appropriate solution for the object beam expression O. In some embodiments, the cost function may have a form of:

$$C ( O , {O}^{*} ) = \frac{1}{2} {‖ H - ( {\vert O \vert}^{2} + {\vert R \vert}^{2} + {OR}^{*} + {O}^{*} R ) ‖}^{2} + α ϕ ( O , {O}^{*} ) ,$$

where the first term in the cost function may represent the data-fit cost and the second term may represent a constraint cost that forces the solution to be a physically meaningful solution. As described above, in some embodiments the constraint cost may be implemented using an edge-preserving constraint technique, such as a total variation technique, a Huber loss function, and/or a pseudo-Huber loss function. The image processor may be configured to select the cost function from one or more known cost functions, or may generate the cost function based on known parameters and/or constraints.

At block 306 (“Perform minimization iteration?”), which may follow block 304 or block 312 (described below), the image processor may determine whether it should perform a minimization iteration of the cost function determined in block 304. For example, if the image processor has just determined the cost function in block 304, it may determine that it should perform at least one minimization iteration, and may proceed to block 308.

At block 308 (“Minimize data-fit cost”), which may follow block 306, the image processor may attempt to minimize the data-fit cost portion of the cost function. In some embodiments, the image processor may perform the data-fit cost minimization using the following scheme:

$${O}_{d}^{( n + 1 )} = {O}^{( n )} - β \frac{[ H - ( {\vert {O}^{( n )} \vert}^{2} + {\vert R \vert}^{2} + {O}^{( n )} {R}^{*} + {O}^{( n ) *} R ) ] ( {O}^{( n )} + R )}{3 {\vert {O}^{( n )} + R \vert}^{2} - H + {ɛ}^{2}} ,$$

where O⁽ⁿ⁾ may be a previous or initial object-image estimate for the object beam expression O, O_{d}⁽ⁿ⁺¹⁾ may be an updated object-image estimate resulting from the data-fit cost minimization, ε may be a small positive constant that ensures division by zero does not occur, and β may be a positive number, preferably between 0 and 1. This scheme may correspond to an exact analogue of a complex Newton iteration technique, and may provide a step size (represented by the denominator in the second term of the scheme) that varies from pixel to pixel. This pixel-dependent step size may aid quadratic convergence in the minimization as compared to a gradient descent scheme with constant step size for all pixels, which may provide relatively slower linear convergence.

When performing the first minimization (in other words, immediately after determining the cost function), the image processor may use an initial value for the object-image estimate. The initial value may be a zero estimate (for example, all zeroes), may be a solution obtained via a Fourier transform method, or may be a guess obtained via any suitable means.

At block 310 (“Minimize constraint cost”), which may follow block 308 or block 312 (described below), the image processor may attempt to minimize the constraint-cost portion of the cost function. In some embodiments, the image processor may perform the minimization using M iterations (where M is one or more) of the following scheme:

O₍ₘ₊₁₎⁽ⁿ⁺¹⁾=O₍ₘ₎⁽ⁿ⁺¹⁾−t[∇_{O}*φ(O,O*)]_{O=O}_{₍ₘ₎}_{⁽ⁿ⁺¹⁾},

where m indicates a particular iteration within the M iterations, O₍ₘ₊₁₎⁽ⁿ⁺¹⁾ may be a current object-image estimate, O₍ₘ₎⁽ⁿ⁺¹⁾ may be the immediately previous object-image estimate, and t is a coefficient that may be derived using a backtracking line search technique in each iteration. In some embodiments, the first object-image estimate (that is, O₍ₘ₎⁽ⁿ⁺¹⁾ for m=0) may be based on the object-image obtained by minimization of the data-fit cost function, or O_{d}⁽ⁿ⁺¹⁾ as described above. The resultant object-image estimate after M constraint cost minimization iterations may be denoted as O⁽ⁿ⁺¹⁾=O_{M}⁽ⁿ⁺¹⁾ and may represent an updated image resulting from one cycle of data-fit and constraint cost minimization.

At block 312, which may follow block 310, the image processor may determine whether the constraint cost minimization in block 310 should be repeated, for example based on the number of constraint cost minimization iterations M described above. In some embodiments, M may be determined such that a distance d₁=∥O⁽ⁿ⁾−O_{d}ⁿ⁺¹⁾∥, which may represent the progress of the solution due to data fit cost minimization, and a distance d₂=∥O_{M}⁽ⁿ⁺¹⁾−O_{d}⁽ⁿ⁺¹⁾∥, which may represent the progress of the solution due to constraint cost minimization, are substantially similar. In other embodiments M may be determined such that d₂>αd₁ where α is a constant in the range of 0 to 1. The distances d₁, d₂ may for example be L-2 norm or other suitable measures to distinguish the corresponding images. If at block 312 the image processor determines that the constraint cost minimization should be repeated, then the image processor may return to block 310. In some embodiments, M may be pre-determined, and the image processor may be configured to perform M iterations of the constraint cost minimization for every data-fit cost minimization. For example, the image processor may be configured to repeat the constraint cost minimization five to ten times for every data-fit cost minimization. In other embodiments, M may be dynamic. For example, the image processor may repeat the constraint cost minimization until the change between a previous object-image estimate and an updated object-image estimate falls below a particular threshold.

On the other hand, if at block 312 the image processor determines that the constraint cost minimization should not be repeated, then the image processor may return to block 306, described above. In some embodiments, upon its return to block 306 the image processor may determine whether additional minimization iterations should be performed based on one or more halt criteria. The halt criteria may include whether the most recent minimization iteration resulted in an updated object-image estimate that is significantly different from the immediately preceding object-image estimate resulting from the immediately preceding minimization iteration, whether a pre-determined number of iterations has been reached, whether an iteration time has been reached, or any other suitable criterion or combination of criteria. If the image processor determines at block 306 that the halt criteria has not been met, then the image processor may proceed to block 308 to repeat the minimization iteration. On the other hand, if the image processor determines at block 306 that one or more of the halt criteria have been met, then the image processor may proceed to block 314.

In some embodiments, the image processor may determine whether an updated object-image estimate is significantly different from the immediately preceding object-image estimate based on a difference between the two object-image estimates. For example, the image processor may compare the difference to a threshold. If the difference is above the threshold, then the image processor may consider the two object-image estimates to be significantly different.

At block 314 (“Recover image from final object-image data”), which may follow block 306, the image processor may attempt to recover a version of the image data associated with the imaged object from the most recent updated object-image estimate. For example, the image processor may recover an object image as described above in FIG. 2.

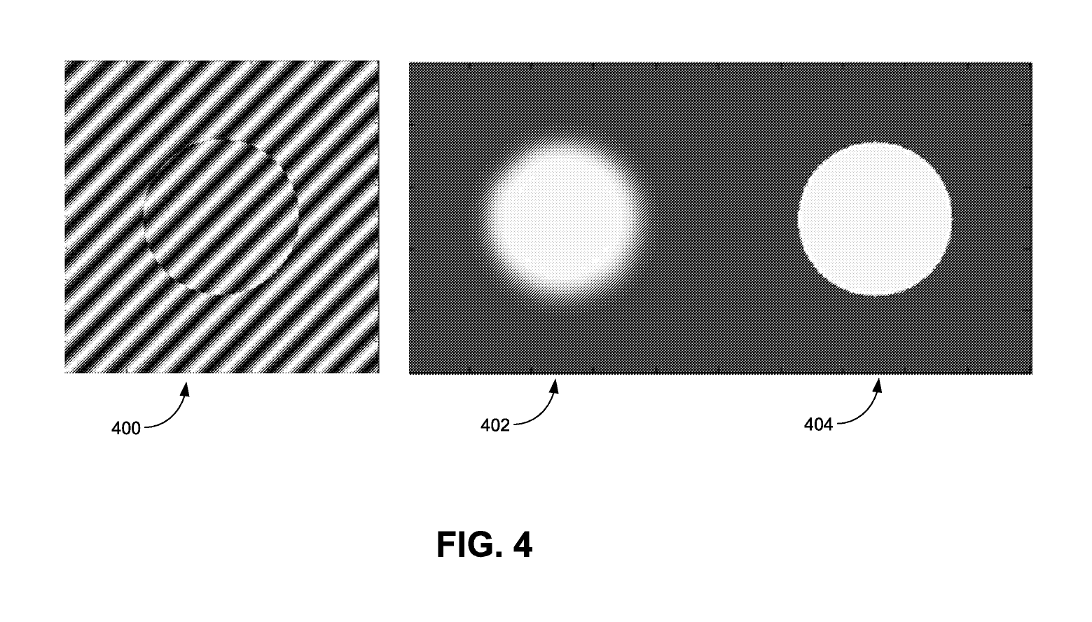

FIG. 4 illustrates example images of a simulated object recovered using a Fourier transform method and the alternating iteration minimization method described in FIG. 3, arranged in accordance with at least some embodiments described herein.

In FIG. 4, image 400 depicts a simulated hologram of a step object, image 402 depicts the step object of image 400 as recovered using a Fourier transform technique, and image 404 depicts the step object of image 400 as recovered using the alternating iteration minimization technique described in FIG. 3. As can be seen, the step object in the image 404, recovered using the technique described in FIG. 3, has relatively higher resolution than the step object in the image 402, recovered using the Fourier transform technique. For example, the circular step boundary of the step object in the image 404 is sharper relative to the step boundary of the object in the image 402. This difference may be due to the use of low-pass filtering in the Fourier transform technique and other such traditional techniques, which may not allow recovery of high frequency components associated with sharp edges in hologram data. In contrast, the technique described herein may allow recovery of high-frequency components, which may result in higher resolution.

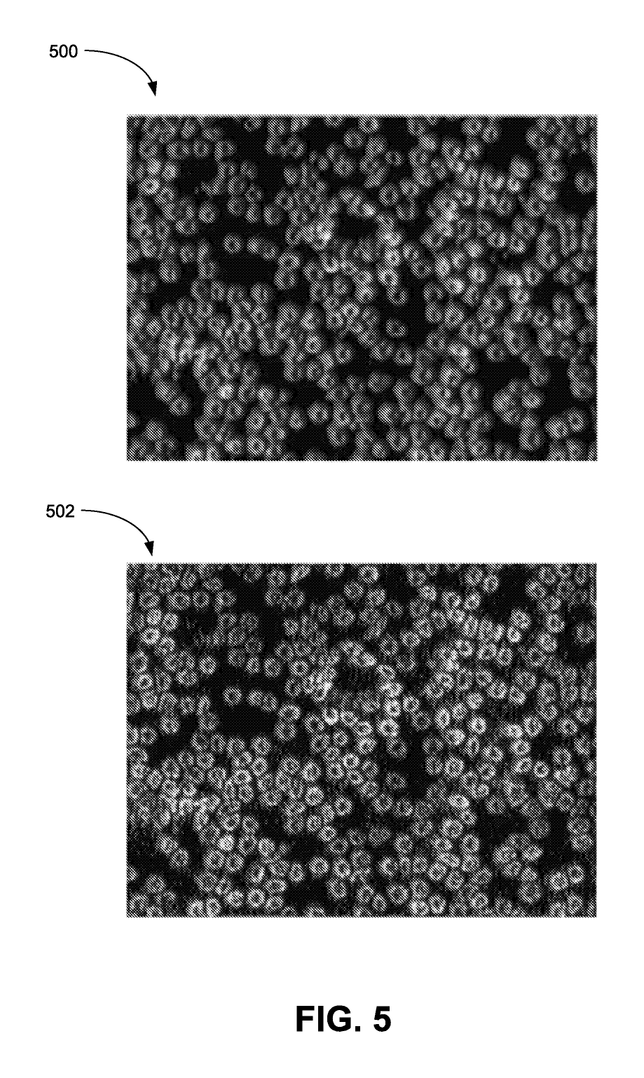

FIG. 5 illustrates example images recovered using a method without alternating iteration and the alternating iteration minimization method described in FIG. 3, arranged in accordance with at least some embodiments described herein.

In FIG. 5, image 500 depicts red blood cell image data recovered using a minimization technique applied to experimental hologram data that does not use the alternating iteration described herein, and further uses a constant step size in the data fit cost function iteration and does not vary the iterations as described above. In contrast, image 502 depicts red blood cell image data recovered using the alternating iteration minimization technique described in FIG. 3. As is apparent, the image data in the image 502 is of relatively higher resolution, with sharper edges, than the image data in the image 504.

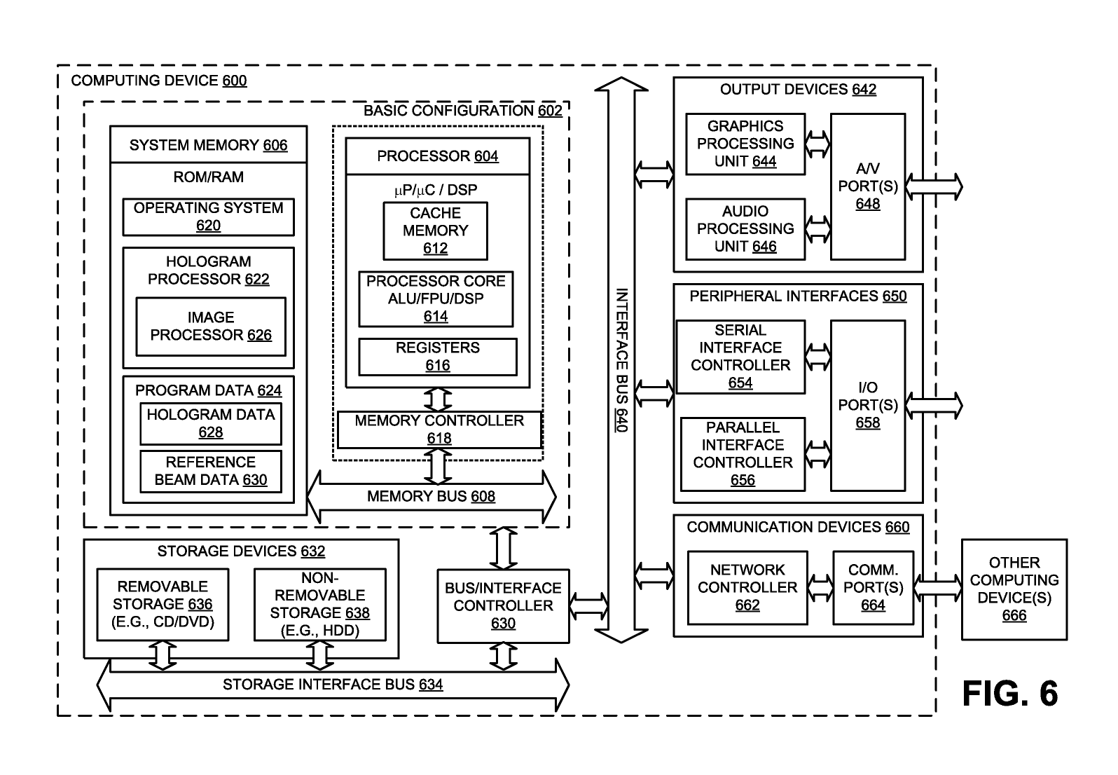

FIG. 6 illustrates a general purpose computing device, which may be used to recover object image data from object hologram data, arranged in accordance with at least some embodiments described herein.

For example, the computing device 600 may be used to recover image data from hologram data as described herein. In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a hologram processor 622, and program data 624. The hologram processor 622 may include an image processor 626 to recover image data from hologram data as described herein. The program data 624 may include, among other data, hologram data 628, reference beam data 630, or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

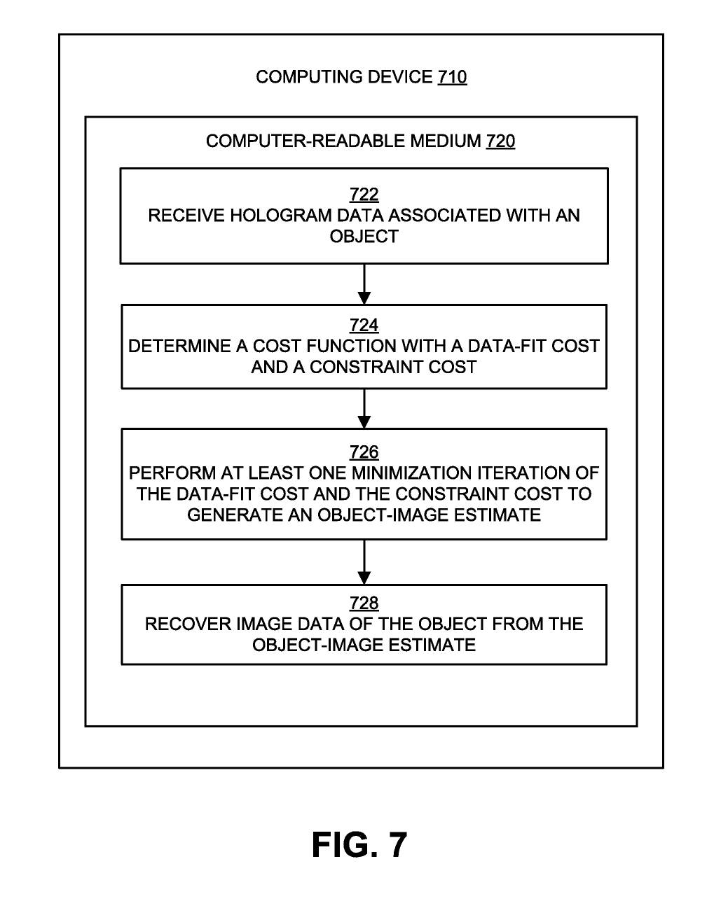

FIG. 7 is a flow diagram illustrating an example method to recover object image data from object hologram data that may be performed by a computing device such as the computing device in FIG. 6, arranged in accordance with at least some embodiments described herein.

Example methods may include one or more operations, functions or actions as illustrated by one or more of blocks 722, 724, 726, and/or 728, and may in some embodiments be performed by a computing device such as the computing device 700 in FIG. 7. The operations described in the blocks 722-728 may also be stored as computer-executable instructions in a computer-readable medium such as a computer-readable medium 720 of a computing device 710.

An example process to recover image data from digital hologram data may begin with block 722, “RECEIVE HOLOGRAM DATA ASSOCIATED WITH AN OBJECT”, where an image processor, such as the image processor 200, may receive hologram data corresponding to a captured interference pattern, where the interference pattern may be formed by interfering a reference beam with an object beam, as described above.

Block 722 may be followed by block 724, “DETERMINE A COST FUNCTION WITH A DATA-FIT COST AND A CONSTRAINT COST”, where the image processor may determine a cost function to use to recover image data from the hologram data, as described above. In some embodiments, the cost function may include a data-fit cost component and a constraint cost component, as described above in FIG. 3.

Block 724 may be followed by block 726, “PERFORM AT LEAST ONE MINIMIZATION ITERATION OF THE DATA-FIT COST AND THE CONSTRAINT COST TO GENERATE AN OBJECT-IMAGE ESTIMATE”, where the image processor may perform one or more minimization iterations of the cost function by alternately minimizing the data-fit cost and the constraint cost. Each minimization may result in an object-image estimate that may then be used for a subsequent minimization, as described above in FIG. 3. In some embodiments, the image processor may continue performing minimization iterations until one or more halt criteria have been met.

Block 726 may be followed by block 728, “RECOVER IMAGE DATA OF THE OBJECT FROM THE OBJECT-IMAGE ESTIMATE”, where the image processor, upon determining that a halt criterion has been met, may recover a version of the object image data from the last object-image estimate generated at block 726, as described above.

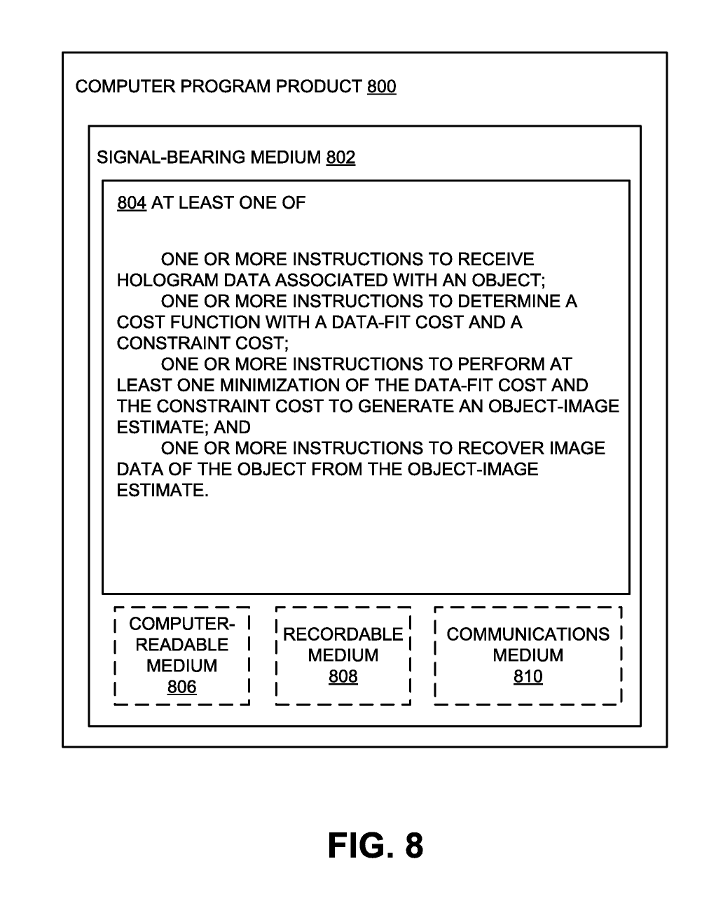

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, when executed by, for example, a processor may provide the functionality described herein. Thus, for example, referring to the processor 604 in FIG. 6, the hologram processor 622 may undertake one or more of the tasks shown in FIG. 8 in response to the instructions 804 conveyed to the processor 604 by the medium 802 to perform actions associated with recovering image data from digital hologram data as described herein. Some of those instructions may include, for example, instructions to receive hologram data associated with an object, determine a cost function with a data-fit cost and a constraint cost, perform at least one minimization of the data-fit cost and the constraint cost to generate an object-image estimate, and/or recover image data of the object from the object-image estimate, according to some embodiments described herein.

In some implementations, the signal bearing media 802 depicted in FIG. 8 may encompass computer-readable media 806, such as, but not limited to, a hard disk drive, a solid state drive, a compact disc (CD), a digital versatile disk (DVD), a digital tape, memory, etc. In some implementations, the signal bearing media 802 may encompass recordable media 807, such as, but not limited to, memory, read/write (R/W) CDs, R/W DVDs, etc. In some implementations, the signal bearing media 802 may encompass communications media 810, such as, but not limited to, a digital and/or an analog communication medium (e.g., a fiber optic cable, a waveguide, a wired communications link, a wireless communication link, etc.). Thus, for example, the program product 800 may be conveyed to one or more modules of the processor 604 by an RF signal bearing medium, where the signal bearing media 802 is conveyed by the wireless communications media 810 (e.g., a wireless communications medium conforming with the IEEE 802.11 standard).

According to some examples, an object image recovery system is provided. The object image recovery system may include a memory and a processor block coupled to the memory. The memory may be configured to store digital hologram data derived from a combination of a reference signal and an unknown object image. The processor block may be configured to determine a data-fit cost based on an object-image intermediate and the reference signal, determine a constraint cost based on the object-image intermediate, and perform one or more minimization iterations of the data-fit cost and the constrain cost. Each minimization iteration may include a minimization of the data-fit cost based on a first object-image estimate to generate a second object-image estimate and one or more minimizations of the constraint cost based on the second object image estimate to generate a third object-image estimate. The processor block may be further configured to, upon determination that a halt criterion has been met, recover a version of the unknown object image from the digital hologram data based on the second object-image estimate and/or the third object-image estimate. In some embodiments, the recovered version of the unknown object image may include a diffraction-limited phase component.

According to some embodiments, the processor block may be configured to perform the minimization of the data-fit cost by performance of a complex Newton iteration and/or based on a pixel-dependent step size. The first object-image estimate may be a Fourier transform solution. In some embodiments, the processor block may be configured to perform the one or more minimizations of the constraint cost based on a backtracking line search and/or an edge-preserving constraint. The edge-preserving constraint may include one or more of a total variation, a Huber loss function, and/or a pseudo-Huber loss function. In some embodiments, the processor block may be further configured to determine that the halt criterion has been met by determination of whether a difference between a first minimization iteration and a subsequent minimization iteration is below a threshold. The processor block may be configured to determine whether the difference is below a threshold based on a comparison of an object-image estimate associated with the first minimization iteration and an object-image estimate associated with the subsequent minimization iteration.

According to other examples, a method is provided to recover object image data from a single image plane hologram. The method may include receiving a digital hologram derived from a reference signal and an unknown object image, determining a data-fit cost associated with the digital hologram and based on an object-image intermediate and the reference signal, and determining a constraint cost associated with the digital hologram and based on the object-image intermediate. The method may further include performing multiple minimization iterations of the data-fit cost and the constraint cost, where each minimization iteration may include performing a minimization of the data-fit cost based on a first object-image estimate to generate a second object-image estimate and performing one or more minimizations of the constraint cost based on the second object-image estimate to generate a third object-image estimate. The method may further include recovering a version of the unknown object image from the digital hologram based on one or more of the second object-image estimate and the third object-image estimate. In some embodiments, the recovered version of the unknown object image may include a diffraction-limited phase component.

According to some embodiments, performing the minimization of the data-fit cost may include performing a complex Newton iteration based on a pixel-dependent step size. The first object-image estimate may be a Fourier transform solution or a zero estimate. In some embodiments, performing the one or more minimizations of the constraint cost may include performing the minimizations based on a backtracking line search and/or an edge-preserving constraint. The edge-preserving constraint may include a total variation, a Huber loss function, and/or a pseudo-Huber loss function.

According to other embodiments, recovering the version of the unknown object image may include recovering the version upon determining that a halt criterion has been met. The halt criterion may include whether a difference between a first minimization iteration and a subsequent minimization iteration is below a threshold. The method may further include determining that the difference is below the threshold by comparing an object-image estimate associated with the first minimization iteration and an object-image estimate associated with the subsequent minimization iteration. In some embodiments, the halt criterion may include a predetermined number of iterations.

According to further examples, a digital holography imaging system is provided. The digital holography imaging system may include a holographic imager and an object image recovery module. The holographic imager may be configured to generate a single-shot digital hologram of an object using a reference signal. The object image recovery module may be configured to determine a cost function associated with the digital hologram and including a data-fit cost and a constraint cost. The object image recovery module may be further configured to alternately perform a first minimization of the cost function by evaluation of the data-fit cost based on a first object-image estimate to generate a second object-image estimate and perform a second minimization of the cost function by evaluation of the constraint cost based on the second object-image estimate to generate a third object-image estimate. The object image recovery module may be further configured to recover a version of the unknown object image from the digital hologram based on one or more of the second object-image estimate and the third object-image estimate. In some embodiments, the recovered version of the unknown object image may include a diffraction-limited phase component.

According to some embodiments, the object image recovery module may be configured to perform the evaluation of the data-fit cost based on a complex Newton iteration and/or a pixel-dependent step size. The first object-image estimate may be a Fourier transform solution. The object image recovery module may be configured to evaluate the constraint based on a backtracking line search and/or an edge-preserving constraint. In some embodiments, the edge-preserving constraint may include a total variation, a Huber loss function, and/or a pseudo-Huber loss function. The object image recovery module may be configured to recover the version of the unknown object image upon determination that a halt criterion has been reached.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In some examples, an object image recovery system comprises a memory configured to store digital hologram data derived from a combination of a reference signal and an unknown object image; and a processor block coupled to the memory and configured to: determine a data-fit cost based on an object-image intermediate and the reference signal; determine a constraint cost based on the object-image intermediate; perform at least one minimization iteration of the data-fit cost and the constraint cost, each minimization iteration comprising: a minimization of the data-fit cost based on a first object-image estimate to generate a second object-image estimate; and at least one minimization of the constraint cost based on the second object-image estimate to generate a third object-image estimate; and upon determination that a halt criterion has been met, recover a version of the unknown object image from the digital hologram data based on at least one of the second object-image estimate and the third object-image estimate, wherein the recovered version includes a diffraction-limited phase component. In some examples, a processor block may be configured to perform the minimization of the data-fit cost by performance of a complex Newton iteration. In some examples, a processor block may be configured to perform the minimization of the data-fit cost based on a pixel-dependent step size. A first object-image estimate may be a Fourier transform solution. A processor block may be configured to perform the at least one minimization of the constraint cost based on a backtracking line search. A processor block may be configured to perform the at least one minimization of the constraint cost based on an edge-preserving constraint. An edge-preserving constraint may include at least one of a total variation, a Huber loss function, and a pseudo-Huber loss function. A processor block may be further configured to determine that the halt criterion has been met by determination of whether a difference between a first minimization iteration and a subsequent minimization iteration is below a threshold. A processor block may be configured to determine whether the difference is below a threshold based on a comparison of an object-image estimate associated with the first minimization iteration and an object-image estimate associated with the subsequent minimization iteration. In some examples, an object image recovery system may be a component of an optical instrument, such as a microscope, in particular a phase microscope. In some examples, an object image recovery system may receive data from an optical instrument, such as a microscope, in particular a phase microscope, and may for example receive data from an image sensor within an optical instrument.

In some examples, a method to recover object image data from a single image plane hologram comprises: receiving a digital hologram derived from a reference signal and an unknown object image; determining a data-fit cost associated with the digital hologram and based on an object-image intermediate and the reference signal; determining a constraint cost associated with the digital hologram and based on the object-image intermediate; performing a plurality of minimization iterations of the data-fit cost and the constraint cost, each minimization iteration comprising: performing a minimization of the data-fit cost based on a first object-image estimate to generate a second object-image estimate; and performing at least one minimization of the constraint cost based on the second object-image estimate to generate a third object-image estimate; and recovering a version of the unknown object image from the digital hologram based on at least one of the second object-image estimate and the third object-image estimate, wherein the recovered version includes a diffraction-limited phase component. Performing the minimization of the data-fit cost may comprise performing a complex Newton iteration based on a pixel-dependent step size. The first object-image estimate may be one of a Fourier transform solution and a zero estimate. Performing the at least one minimization of the constraint cost may comprise performing the at least one minimization based on a backtracking line search. Performing the at least one minimization of the constraint cost may comprise performing the at least one minimization based on an edge-preserving constraint. An edge-preserving constraint may include at least one of a total variation, a Huber loss function, and a pseudo-Huber loss function. Recovering the version of the unknown object image may comprise recovering the version upon determining that a halt criterion has been met. A halt criterion may include whether a difference between a first minimization iteration and a subsequent minimization iteration is below a threshold. Determining that the difference is below the threshold may comprise comparing an object-image estimate associated with the first minimization iteration and an object-image estimate associated with the subsequent minimization iteration. A halt criterion may include a predetermined number of iterations, for example reaching a predetermined number of iterations.

In some examples, a digital holography imaging system comprises: a holographic imager configured to generate a digital hologram (for example, a single-shot digital hologram) of an object using a reference signal; and an object image recovery module configured to: determine a cost function associated with the digital hologram and including a data-fit cost and a constraint cost; alternately: perform a first minimization of the cost function by evaluation of the data-fit cost based on a first object-image estimate to generate a second object-image estimate; and perform a second minimization of the cost function by evaluation of the constraint cost based on the second object-image estimate to generate a third object-image estimate; and recover a version of the unknown object image from the digital hologram based on at least one of the second object-image estimate and the third object-image estimate, wherein the recovered version includes a diffraction-limited phase component. An object image recovery module may be configured to perform the evaluation of the data-fit cost based on at least one of a complex Newton iteration and a pixel-dependent step size. A first object-image estimate may comprise or otherwise be based on a Fourier transform solution. An object image recovery module may be configured to evaluate the constraint cost based on at least one of a backtracking line search and an edge-preserving constraint. An edge-preserving constraint may include at least one of a total variation, a Huber loss function, and a pseudo-Huber loss function. An object image recovery module may be configured to recover the version of the unknown object image upon determination that a halt criterion has been reached.

In some examples, a digital holography imager system comprises a holographic imager, such a microscope, camera, video camera, or other optical instrument, configured to generate a hologram of an object. An imager system may comprise an object holder configured to hold an object to be imaged. A hologram may be formed by interference between light that has passed through the object and light that does not pass through the object (e.g. a reference signal). A beam splitter may be used to obtain a reference signal, for example by splitting a laser beam (or light from another light source) into two portions, the imager being configured so that a reference signal is derived from one portion and at least part of the other portion passes through the object when the object is placed in or otherwise supported by an object holder. Lenses, which may include one or more microscope objective lenses in the example of a microscope, may be used to focus light onto and collect light from the object. Light may be transmitted through an object, or in some examples an optical instrument may be configured such that light is reflected from an object and a hologram formed using the reflected light. A light source may provide visible light, and in some examples a light source may additionally or alternatively provide UV light or IR (such as near-IR) light, or other electromagnetic wave.

In some examples, interference (e.g. between light that has passed through an object and a reference signal) may occur at an electronic sensor, and a digital hologram may be obtained from the electronic sensor as an electronic signal. A digital hologram may be used to obtain phase and amplitude data, and in some examples dynamic time dependent data, related to the object. An image of the object may be formed from the digital hologram signal, and the image may be used to display information such as optical features of the object (e.g. thickness, refractive index, color, and the like). In some examples, a 3D display may be used to display a 3D representation of the object.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An object image recovery system comprising:
a memory configured to store digital hologram data derived from a combination of a reference signal and an unknown object image; and
a processor block coupled to the memory and configured to:
determine a data-fit cost based on an object-image intermediate and the reference signal;
determine a constraint cost based on the object-image intermediate;
perform at least one minimization iteration of the data-fit cost and the constraint cost, each minimization iteration comprising:
a minimization of the data-fit cost based on a first object-image estimate to generate a second object-image estimate; and
at least one minimization of the constraint cost based on the second object-image estimate to generate a third object-image estimate; and
upon determination that a halt criterion has been met, recover a version of the unknown object image from the digital hologram data based on at least one of the second object-image estimate and the third object-image estimate, wherein the recovered version includes a diffraction-limited phase component.

2. The system of claim 1, wherein the processor block is configured to perform the minimization of the data-fit cost by performance of a complex Newton iteration.

3. The system of claim 1, wherein the processor block is configured to perform the minimization of the data-fit cost based on a pixel-dependent step size.

4. (canceled)

5. The system of claim 1, wherein the processor block is configured to perform the at least one minimization of the constraint cost based on a backtracking line search.

6. The system of claim 1, wherein the processor block is configured to perform the at least one minimization of the constraint cost based on an edge-preserving constraint.

7. (canceled)

8. The system of claim 1, wherein the processor block is further configured to determine that the halt criterion has been met by determination of whether a difference between a first minimization iteration and a subsequent minimization iteration is below a threshold.

9. The system of claim 8, wherein the processor block is configured to determine whether the difference is below a threshold based on a comparison of an object-image estimate associated with the first minimization iteration and an object-image estimate associated with the subsequent minimization iteration.

10. A method to recover object image data from a single image plane hologram, the method comprising:
receiving a digital hologram derived from a reference signal and an unknown object image;
determining a data-fit cost associated with the digital hologram and based on an object-image intermediate and the reference signal;
determining a constraint cost associated with the digital hologram and based on the object-image intermediate;
performing a plurality of minimization iterations of the data-fit cost and the constraint cost, each minimization iteration comprising:
performing a minimization of the data-fit cost based on a first object-image estimate to generate a second object-image estimate; and
performing at least one minimization of the constraint cost based on the second object-image estimate to generate a third object-image estimate; and
recovering a version of the unknown object image from the digital hologram based on at least one of the second object-image estimate and the third object-image estimate, wherein the recovered version includes a diffraction-limited phase component.

11. The method of claim 10, wherein performing the minimization of the data-fit cost comprises performing a complex Newton iteration based on a pixel-dependent step size.

12. The method of claim 10, wherein the first object-image estimate is one of a Fourier transform solution and a zero estimate.

13. The method of claim 10, wherein performing the at least one minimization of the constraint cost comprises performing the at least one minimization based on a backtracking line search.

14. The method of claim 10, wherein performing the at least one minimization of the constraint cost comprises performing the at least one minimization based on an edge-preserving constraint.

15. The method of claim 10, wherein the edge-preserving constraint includes at least one of a total variation, a Huber loss function, and a pseudo-Huber loss function.

16. The method of claim 10, wherein recovering the version of the unknown object image comprises recovering the version upon determining that a halt criterion has been met.

17. The method of claim 16, wherein the halt criterion includes whether a difference between a first minimization iteration and a subsequent minimization iteration is below a threshold.

18. (canceled)

19. (canceled)

20. A digital holography imaging system, comprising:
a holographic imager configured to generate a single-shot digital hologram using a reference signal; and
an object image recovery module configured to:
determine a cost function associated with the digital hologram and including a data-fit cost and a constraint cost;
perform a first minimization of the cost function by evaluation of the data-fit cost based on a first object-image estimate to generate a second object-image estimate; and recover a version of the unknown object image from the digital hologram based on the second object-image estimate, wherein the recovered version includes a diffraction-limited phase component.

21. The system of claim 20, wherein the object image recovery module is further configured to:
perform a second minimization of the cost function by evaluation of the constraint cost based on the second object-image estimate to generate a third object-image estimate; and
recover the version of the unknown object image from the digital hologram further based on the third object-image estimate.

22. The system of claim 20, wherein the object image recovery module is configured to perform the evaluation of the data-fit cost based on at least one of a complex Newton iteration and a pixel-dependent step size.

23. (canceled)

24. The system of claim 20, wherein the object image recovery module is configured to evaluate the constraint cost based on at least one of a backtracking line search and an edge-preserving constraint.

25. (canceled)

26. The system of claim 20, wherein the object image recovery module is configured to recover the version of the unknown object image upon determination that a halt criterion has been reached.
